(19) United States
(12) Patent Application Publication
(10) Pub. No.: US 2024/0212895 A1
(43) Pub. Date: Jun. 27, 2024

(54) SINTERED R-T-B BASED MAGNET

(71) Applicant: Proterial, Ltd., Tokyo (JP)

(72) Inventor: Futoshi KUNIYOSHI, Tokyo (JP)

(73) Assignee: Proterial, Ltd., Tokyo (JP)

(21) Appl. No.: 18/392,010

(22) Filed: Dec. 21, 2023

(30) Foreign Application Priority Data
Dec. 27, 2022 (JP) 2022-210643

(51) Int. Cl. H01F 1/057

(52) U.S. Cl. CPC H01F 1/0577

(57) ABSTRACT

Provided is a sintered R-T-B based magnet having high Br and high H_{cJ}. A sintered R-T-B based magnet containing: R: 26.8 to 31.5 mass % (R is a rare earth element, and contains one or two selected from the group consisting of Nd and Pr); M: 0.05 to 2.00 mass % (M is at least one selected from the group consisting of Ga, Cu, Zn, Al, and Si, and necessarily contains Cu); B: 0.84 to 0.94 mass %; and T: 61.5 mass % or more (T is Fe and Co, and 90% or more of T is Fe in mass ratio), and having an internal structure, wherein the internal structure includes: crystal grains; a first phase between adjacent two crystal grains; and a second phase with a Cu concentration higher than that of the first phase between at least any one of the two crystal grains and the first phase, wherein the second phase contains F in a range of 2 to 20 mass % and has a higher F concentration than the first phase.

### TECHNICAL FIELD

The present disclosure relates to a sintered R-T-B based magnet.

### BACKGROUND ART

Sintered R-T-B based magnets (R is at least one of rare earth elements; T is Fe, or Fe and Co; and B is boron) are known as permanent magnets with the highest performance. For this reason, sintered R-T-B based magnets are in use in various motors in the automobile field including electric vehicles (EV, HV, PHV), the renewable energy field including wind power generation, the home electric appliance field, the industrial field, and so on. Sintered R-T-B based magnets are materials essential for miniaturization, weight reduction, increase in efficiency, and energy saving (improvement in energy efficiency) of these motors. In addition, sintered R-T-B based magnets are used in drive motors for electric vehicles, and through the replacement of internal combustion engine vehicles with electric vehicles, sintered R-T-B based magnets also contribute to prevention of global warming by reduction of greenhouse gases such as carbon dioxide (reduction of fuel and exhaust gas). As described above, sintered R-T-B based magnets greatly contribute to the realization of a clean energy society.

Sintered R-T-B based magnets are composed of crystal grains made of an R₂T₁₄B type compound and grain boundary phases located at grain boundary portions of the crystal grains (for example, Patent Document 1). Patent Document 1 discloses a sintered rare earth magnet comprising R₂T₁₄B main-phase crystal grains and intergranular grain boundary phases between adjacent two R₂T₁₄B main-phase crystal grains, wherein the thickness of the intergranular grain boundary phases is 5 nm or more and 500 nm or less and the intergranular grain boundary phases are composed of phases with a magnetism different from that of a ferromagnet.

The R₂T₁₄B-type compound constituting the crystal grains is a ferromagnetic material having high saturation magnetization and an anisotropic magnetic field, and affects the characteristics of sintered R-T-B based magnets.

Sintered R-T-B based magnets have a problem that irreversible thermal demagnetization occurs because the coercivity H_{cJ} (hereinafter, simply referred to as “H_{cJ}”) decreases at high temperatures. Therefore, in particular, a sintered R-T-B based magnet to be used for a motor for an electric vehicle is required to have high H_{cJ} even at high temperatures, that is, to have higher H_{cJ} at room temperature.

### Patent Document

Patent Document 1: JP 2014-209546 A

### SUMMARY

### Problems to be Solved by the Invention

It is known that when a light rare earth element RL (mainly Nd and Pr) in an R₂T₁₄B-type compound is replaced by a heavy rare earth element RH (mainly Tb and Dy), H_{cJ} is improved. However, while H_{cJ} is improved, there is a problem that the saturation magnetization of the R₂T₁₄B-type compound phase decreases, and thus the residual magnetic flux density Bᵣ (hereinafter, simply referred to as “Bᵣ”) decreases. In particular, Tb has problems such as unstable supply and price fluctuation due to, for example, its originally small resource amount and limited production sites. Therefore, it is required to obtain high H_{cJ} while inhibiting a decrease in Bᵣ with using Tb as less as possible (with reducing the amount used as much as possible).

The sintered rare earth magnet disclosed in Patent Document 1 is said to be capable of inhibiting a decrease in H_{cJ} at high temperatures while reducing the amount of heavy rare earth elements RH such as Tb used, but in recent years, Bᵣ and H_{cJ} are required to be further improved particularly in motors for electric vehicles and the like.

Therefore, an object of an embodiment of the present invention is to provide a sintered R-T-B based magnet capable of further improving Bᵣ and H_{cJ} while reducing the amount of heavy rare earth elements RH such as Tb used.

### Solutions to the Problems

An aspect 1 of the present invention is
a sintered R-T-B based magnet comprising:
R: 26.8 to 31.5 mass % (R is a rare earth element, and contains one or two selected from the group consisting of Nd and Pr);
M: 0.05 to 2.00 mass % (M is at least one selected from the group consisting of Ga, Cu, Zn, Al, and Si, and necessarily contains Cu);
B: 0.84 to 0.94 mass %; and
T: 61.5 mass % or more (T is Fe and Co, and 90% or more of T is Fe in mass ratio), and
having an internal structure,
wherein the internal structure includes:
crystal grains;
a first phase between adjacent two crystal grains; and
a second phase with a Cu concentration higher than that of the first phase between one or both of the two crystal grains and the first phase,
wherein the second phase contains F in a range of 2 to 20 mass % and has a higher F concentration than the first phase.

An aspect 2 of the present invention is
the sintered R-T-B based magnet according to the aspect 1, wherein the second phase is further included between each of the two crystal grains and the first phase.

An aspect 3 of the present invention is
the sintered R-T-B based magnet according to the aspect 1 or 2,
wherein the first phase comprises:
R: 15 to 65 mass %;
M: 2 to 20 mass %;
F: 3 mass % or less (including 0 mass %); and
T: 20 to 80 mass %, and
the second phase comprises:
R: 15 to 65 mass %;
M: 2 to 20 mass %;
F: 2 to 20 mass %; and
T: 20 to 80 mass %.

An aspect 4 of the present invention is
the sintered R-T-B based magnet according to any one of the aspects 1 to 3, wherein the concentration of the one or two selected from the group consisting of Nd and Pr and the Cu concentration gradually decrease in a range from a surface to a depth of 200 μm.

An aspect 5 of the present invention is
the sintered R-T-B based magnet according to any one of the aspects 1 to 4, wherein M further necessarily contains Ga.

An aspect 6 of the present invention is
the sintered R-T-B based magnet according to any one of the aspects 1 to 5, further comprising at least one selected from the group consisting of:
Tb: more than 0 mass % and 0.10 mass % or less; and
Dy: more than 0 mass % and 0.20 mass % or less.

An aspect 7 of the present invention is
the sintered R-T-B based magnet according to any one of the aspects 1 to 6, satisfying the following Formula (1):

$$26. mass \% \leq ( [ Nd ] + [ Pr ] + [ Ce ] + [ La ] + [ Dy ] + [ Tb ] ) - 12 ( [ O ] + [ C ] ) \leq \text{} 27.7 mass \% \qquad ( 1 )$$

wherein [Nd], [Pr], [Ce], [La], [Dy], [Tb], [O], and [C] are the contents of Nd, Pr, Ce, La, Dy, Tb, O, and C expressed in mass %, respectively.

### Effects of the Invention

According to embodiments of the present disclosure, it is possible to provide a sintered R-T-B based magnet in which Bᵣ and H_{cJ} are further improved while reducing the amount of heavy rare earth elements RH such as Tb used.

### BRIEF DESCRIPTION OF DRAWINGS

FIG. 1A is a cross-sectional view schematically illustrating a part of a sintered R-T-B based magnet in an enlarged manner;

FIG. 1B is a cross-sectional view schematically illustrating the inside of the broken-line rectangular region of FIG. 1A in a further enlarged manner;

FIG. 2 is a cross-sectional view schematically illustrating an intergranular grain boundary;

FIG. 3A is a TEM photograph of cross-sectional observation of a sintered R-T-B based body prepared in Example; and

FIG. 3B is an enlarged TEM photograph of a part of FIG. 3A (the part surrounded by the square).

### DETAILED DESCRIPTION

The present inventors have extensively conducted studies for improving magnetic characteristics (especially, Bᵣ and H_{cJ}) of a sintered R-T-B based magnet while reducing the amount of heavy rare earths used. Then, the present inventors have accomplished an invention relating to the embodiments of the present disclosure by finding that it is possible to obtain a sintered R-T-B based magnet having superior magnetic characteristics because of being a sintered R-T-B based magnet that satisfies a specific component composition and has a configuration in which a grain boundary phase between crystal grains includes a first phase and a second phase being disposed between the crystal grains and the first phase and having a Cu concentration higher than that of the first phase, wherein the second phase contains F in a range of 2 to 20 mass % and has a higher F concentration than that of the first phase.

In the following, a sintered R-T-B based magnet (hereinafter, sometimes simply referred to as a “sintered magnet”) according to an embodiment is described in detail.

### Sintered R-T-B Based Magnet

The sintered R-T-B based magnet comprises:
R: 26.8 to 31.5 mass % (R is a rare earth element, and contains one or two selected from the group consisting of Nd and Pr);
M: 0.05 to 2.00 mass % (M is at least one selected from the group consisting of Ga, Cu, Zn, Al, and Si, and necessarily contains Cu);
B: 0.84 to 0.94 mass %; and
T: 61.5 mass % or more (T is Fe and Co, and 90% or more of T is Fe in mass ratio).

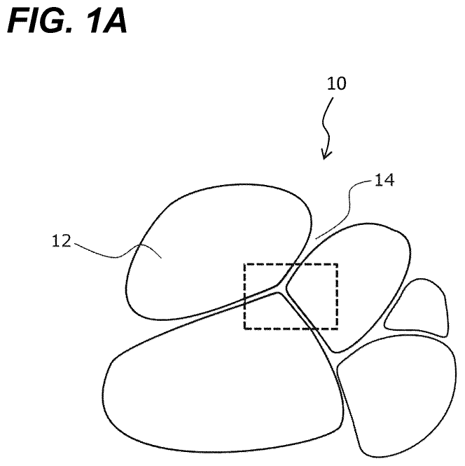

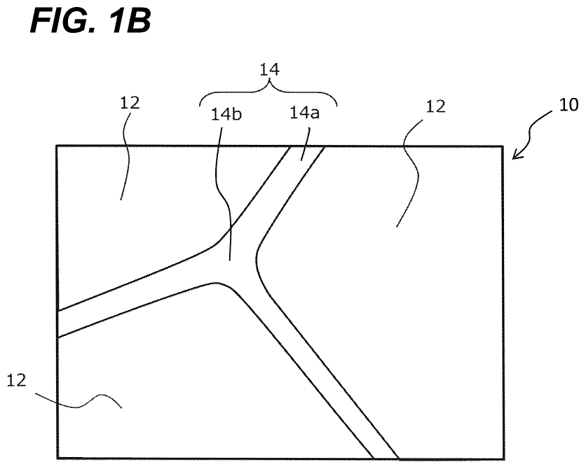

As illustrated in FIGS. 1A and 1B, the internal structure of the sintered magnet 10 includes crystal grains 12 mainly made of an R₂T₁₄B compound and a grain boundary phase 14 located between the crystal grains 12.

The grain boundary phase 14 includes an intergranular grain boundary phase 14a existing between two adjacent crystal grains 12 and a grain boundary triple junction 14b at which two or more intergranular grain boundary phases 14a intersect.

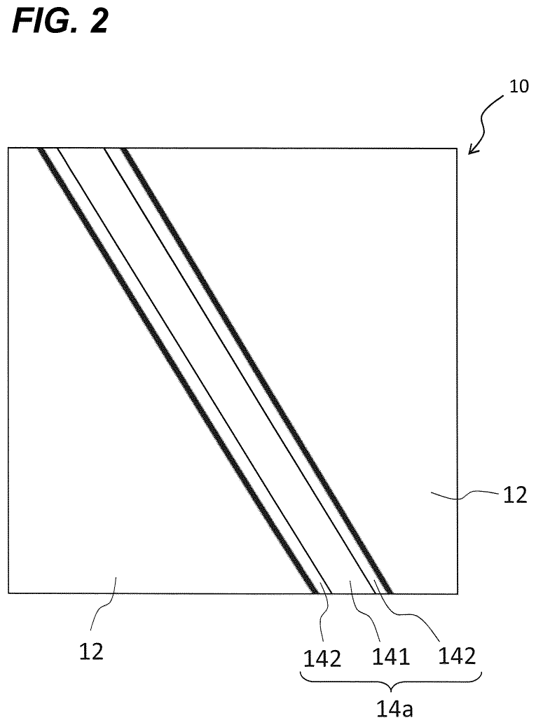

As illustrated in FIG. 2, in the sintered magnet 10 according to the embodiment, the intergranular grain boundary phase 14a includes a first phase 141, and a second phase 142 between the first phase 141 and one or both of two crystal grains 12. That is, the intergranular grain boundary phase 14a has the first phase and the second phase differing in Cu content from each other. The second phase 142 may be formed only between the first phase 141 and one of the two crystal grains 12, but is preferably formed between the first phase 141 and each of the two crystal grains 12.

The Cu concentration of the second phase 142 is higher than the Cu concentration of the first phase 141. The F concentration of the second phase 142 is in the range of 2 to 20 mass % and is higher than the F concentration of the first phase 141.

The present inventors have confirmed that the intergranular grain boundary phase 14a of the sintered magnet 10 has an internal structure including the first phase 141 and the second phase 142 as described above and, owing to the structure, can achieve high magnetic characteristics. The reason why high magnetic characteristics can be realized by including such an intergranular grain boundary phase 14a is not clear, but it is considered that the lattice matching among the main phase (crystal grains 12), the second phase 142, and the first phase 142 is improved by the high F concentration of the second phase 141.

The F contained in the second phase 142 may be derived from the element F contained in a trace amount in a raw material of the sintered magnet 10. In choosing a raw material of the sintered magnet 10, for example, a recycled raw material containing the element F may be chosen. When the F content in the raw material of the sintered magnet 10 is excessively low, the element F may be positively added.

When the sintered magnet 10 contains a heavy rare earth element RH, the content thereof is desirably smaller than the conventional level. In particular, the content of the heavy rare earth element RH is preferably limited to at least one selected from the group consisting of:
Tb: more than 0 mass % and 0.10 mass % or less; and
Dy: more than 0 mass % and 0.20 mass % or less.

Owing to having an internal structure like that described above, the sintered magnet 10 according to the embodiment can achieve superior magnetic characteristics even if the contents of Tb and Dy, which are heavy rare earth elements RH, are controlled to 0.10 mass % or less and 0.20 mass % or less, respectively.

The sintered magnet 10 preferably satisfies the following Formula (1).

$$26. mass \% \leq ( [ Nd ] + [ Pr ] + [ Ce ] + [ La ] + [ Dy ] + [ Tb ] ) - 12 ( [ O ] + [ C ] ) \leq 27.7 mass \% \qquad ( 1 )$$

wherein [Nd], [Pr], [Ce], [La], [Dy], [Tb], [O], and [C] are the contents of Nd, Pr, Ce, La, Dy, Tb, O, and C expressed in mass %, respectively.

When the sintered magnet does not contain any one or more of Nd, Pr, Ce, La, Dy, Tb, O, and C, the content of the element not contained is regarded as “0 mass %”, which is substituted into the Formula (1).

Higher Bᵣ and H_{cJ} can be obtained by adjusting the contents of R, O, and C in the sintered magnet 10 such that the above Formula (1) is satisfied. The content of C can be adjusted by adjusting the amount of the lubricant to be added in pulverization or molding.

As defined in Formula (1), the value of the middle part is preferably 26.0 mass % or more and 27.7 mass % or less, and more preferably 26.0 mass % or more and 27.5 mass % or less. It is possible to obtain high Bᵣ and H_{cJ} while further reducing the amount of heavy rare earth elements RH such as Tb used.

Regarding the component composition of the respective phases contained in the intergranular grain boundary phase 14a,
the first phase 141 preferably comprises:
R: 15 to 65 mass %,
M: 2 to 20 mass %,
F: 3 mass % or less (including 0 mass %), and
T: 20 to 80 mass %,
and the second phase 142 of the intergranular grain boundary phase 14a preferably comprises:
R: 15 to 65 mass %,
M: 2 to 20 mass %,
F: 2 to 20 mass %, and
T: 20 to 80 mass %.

Each of the first phase 141 and the second phase 142 having such a component composition typically has a crystal structure of R₆T₁₃M, and may also contain R₆T_{12.5}M_{1.5} or the like. At least Cu is contained as M, and the Cu concentration of the second phase 142 is set higher than the Cu concentration of the first phase 141. It is considered that when the first phase 141 and the second phase 142 contain such a crystal structure, the magnetic interaction between the main phase grains (crystal grains 12) is reduced.

Element concentrations in the first phase 141 and the second phase 142 can be measured by SEM-EDX or TEM-EDX analysis.

The thickness of the first phase 141 is preferably 10 nm to 500 nm, and more preferably 20 nm to 300 nm. Within such a range, it is possible to control a decrease in magnetic characteristics due to a decrease in the main phase ratio while obtaining an effect of reducing the magnetic interaction between the main phase grains (crystal grains 12).

The thickness of the second phase 142 is preferably 0.5 nm to 10 nm, and more preferably 1 nm to 5 nm. Within such a range, it is possible to control a decrease in magnetic characteristics due to a decrease in the main phase ratio while satisfying the role of improving the lattice matching.

The respective component compositions of the sintered magnet 10 will be described in detail.

(R: 26.8 to 31.5 mass %)

R is a rare earth element, and contains one or two selected from the group consisting of Nd and Pr. The content of R is 26.8 to 31.5 mass %. When the content of R is less than 26.8 mass %, there may arise difficulty in densification during sintering, and when the content of R is more than 31.5 mass %, the ratio of the main phase may decrease, leading to a decrease in Bᵣ. The content of R is preferably 26.8 to 30.0 mass %. When the content of R is in such a range, higher Bᵣ can be obtained.

(M: 0.05 to 2.00 mass %)

M is at least one selected from the group consisting of Ga, Cu, Zn, Al, and Si, and necessarily contains Cu. The content of M (the total content of Ga, Cu, Zn, Al, and Si) is 0.05 to 2.00 mass %. When M is contained in this range, the temperature coefficient may be improved and high H_{cJ} can be achieved at high temperatures.

The sintered magnet 10 necessarily contains Cu as M, and preferably further contains Ga, and H_{cJ} can thereby be further improved.

Cu is contained in both the crystal grains 12 and the intergranular grain boundary phase 14a. In particular, the Cu concentration in the second phase 142 of the intergranular grain boundary phase 14a is high, and as described later, the Cu concentration can be in the range of 2 to 20 mass %. That is, Cu is concentrated in the second phase 142 of the sintered magnet 10. The first phase 141 may also contain Cu, but has a Cu concentration lower than that of the second phase 142.

Cu may be derived from a raw material, or may be derived from Cu diffused from a surface of a sintered body in a diffusion step performed after a sintering step.

(B: 0.84 to 0.94 mass %)

The content of B is 0.84 to 0.94 mass %. When the sintered magnet 10 contains B within the range of the present disclosure, the temperature coefficient is improved and high Her can be achieved even at high temperatures.

(T: 61.5 mass % or more)

T is Fe and Co, and 90% or more of T is Fe in mass ratio. When Co is contained, corrosion resistance can be improved, but when the replacement amount of Co exceeds 10 mass % of T, there is a possibility that high Bᵣ is not obtained. The content of T is 61.5 mass % or more. When the content of T is less than 61.5 mass %, there is a possibility that Bᵣ significantly decreases. Preferably, T is the balance.

The sintered magnet 10 may contain Cr, Mn, La, Ce, Sm, Ca, Mg, or the like as inevitable impurities usually contained in didymium alloy (Nd—Pr), electrolytic iron, ferroboron, and the like. Furthermore, examples of the inevitable impurities contained during a production process include O (oxygen), N (nitrogen), and C (carbon).

The sintered magnet 10 according to the embodiment may contain one or more other elements. For example, as such an element, a small amount (about 0.1 mass %) of Ag, Zn, In, Sn, Ti, Ge, Y, H, F, P, S, V, Ni, Mo, Hf, Ta, W, Nb, Zr, or the like may be contained. Such elements may be contained in a total amount of, for example, about 1.0 mass %. With this degree of content, it is sufficiently possible to obtain a sintered R-T-B based magnet having high H_{cJ} at high temperatures.

Among these elements contained in a small amount, F is an essential element necessarily contained in the first phase 141 of the intergranular grain boundary phase 14a of the sintered magnet 10, but is hardly in the crystal grains 12, and thus F is treated as an element contained in a small amount as a component composition of the sintered magnet 10. However, as described above, the fact that the prescribed amount of F is contained in the second phase 142 can be confirmed by subjecting the intergranular grain boundary phase 14a to SEM-EDX or TEM-EDX analysis.

F may be intentionally added to the raw material such that the second phase 142 and, if necessary, the first phase 141 contain F in a prescribed amount.

In the sintered magnet 10 in the embodiment, the concentration of one or two selected from the group consisting of Nd and Pr may gradually decrease in a range from a surface to a depth of 200 μm. In addition, the Cu concentration may also gradually decrease in a range from the surface to a depth of 200 μm. A sintered magnet 10 having such a concentration distribution is obtained by conducting a step of performing, in the production of the sintered magnet 10, diffusion from a surface of the magnet toward the inside of the magnet using a diffusion source containing one or two selected from the group consisting of Nd and Pr and Cu.

Although the magnetic characteristics of the resulting sintered magnet 10 can be improved by performing the diffusion step in the production of the sintered magnet 10, a sintered magnet 10 with the internal structure as described above having sufficiently superior magnetic characteristics can be obtained even if the diffusion step is omitted.

The concentrations of Nd, Pr, and Cu in the range from a surface to the depth of 200 μm can be confirmed by performing line analysis in the range from a surface of the magnet toward the vicinity of the center of the magnet to a depth of 200 μm in a cross section of the sintered magnet 10 by energy dispersive X-ray spectroscopy (EDX). It is preferable that the measurement is performed in a cross section perpendicular to the surface and 200 μm or more away from the end of the surface. In addition, in the line analysis, measurement is performed in a direction orthogonal to the surface (the outer periphery of the measurement cross section) in a region 200 μm or more away from the end of the measurement cross section in order not to measure a range within 200 μm from the outer periphery of the measurement cross section.

### Method for Producing Sintered R-T-B Based Magnet

In the following, an embodiment of the method for producing the sintered R-T-B based magnet of the present disclosure will be described.

The production method in the present embodiment can comprise a step of preparing a sintered R-T-B based body, a step of preparing an R-M alloy, a step of performing a first heat treatment, and a step of performing a second heat treatment. The step of performing the first heat treatment is a step in which at least a part of the R-M alloy is brought into contact with at least a part of a surface of the sintered R-T-B based body and then R and M are diffused into the magnet by performing the first heat treatment at a temperature of 700° C. or more and 950° C. or less in a vacuum or an inert gas atmosphere. The step of performing the second heat treatment is a step in which the sintered R-T-B based magnet resulting from the first heat treatment is subjected to the second heat treatment at a temperature that is 450° C. or more and 750° C. or less and is lower than the temperature of the first heat treatment, in a vacuum or an inert gas atmosphere. In the following, each of these steps will be described in more detail.

### (Step of Preparing Sintered R-T-B Based Body)

First, the composition of the sintered R-T-B based body is described.

The sintered R-T-B based body to be prepared in this step has, for example, the following composition:
R: 26.6 mass % or more and 31.3 mass % or less (R is a rare earth element, and contains one or two selected from the group consisting of Nd and Pr);
M: 0.05 mass % or more and 2.00 mass % or less (M is at least one selected from the group consisting of Ga, Cu, Zn, Al, and Si, and necessarily contains Cu);
B: 0.84 mass % or more and 0.94 mass % or less; and
T: 61.5 mass % or more (T is Fe and Co, and 90% or more of T is Fe in mass ratio).

The balance may be T and inevitable impurities.

Next, a method for preparing the sintered R-T-B based body is described.

First, an alloy for a sintered R-T-B based magnet is prepared, and then this alloy is coarsely pulverized by, for example, hydrogen pulverization or the like.

Examples of the method for producing the alloy for a sintered R-T-B based magnet will be described. An alloy ingot can be obtained by an ingot casting method in which a metal or an alloy adjusted in advance to have the above-described composition is melted, put into a mold, and solidified. Alternatively, an alloy may also be produced by a strip casting method in which a molten metal or alloy adjusted in advance to have the composition described above is quenched by being brought into contact with a single roll, a twin roll, a rotating disk, a rotating cylindrical mold, or the like and thus a quenched solidified alloy is made. Still alternatively, a flaky alloy may also be produced by another quenching method such as a centrifugal casting method.

In the embodiment of the present disclosure, an alloy produced by either the ingot method or the quenching method can be used, and it is preferable to use an alloy produced by the quenching method such as the strip casting method. The alloy prepared by the quenching method usually has a thickness in the range of 0.03 mm to 1 mm, and is flake-like. The molten alloy starts to solidify from a surface thereof in contact with a cooling roll (roll contact surface), and a crystal grows in a columnar shape in a thickness direction from the roll contact surface. The quenched alloy has been cooled in a shorter time period than an alloy (alloy ingot) produced by the conventional ingot casting method (mold casting method), and as a result, has a finer structure and a shorter crystal grain size. In addition, the area of grain boundaries is wide. Since an R-rich phase largely expands in grain boundaries, the quenching method is highly effective in dispersing the R-rich phase. For this reason, the R-rich phase is easily broken at the grain boundaries by hydrogen pulverization. By subjecting the quenched alloy to hydrogen pulverization, the size of the hydrogen pulverized powder (coarsely pulverized powder) can be adjusted to, for example, 1.0 mm or less. The coarsely pulverized powder thus obtained is pulverized by, for example, a jet mill.

In the present embodiment, it is preferable to control the oxygen content such that the sintered R-T-B based magnet finally obtained satisfies the above Formula (1). The control of the oxygen content can be achieved by adjusting the conditions of pulverization. The oxygen content of the sintered R-T-B based magnet is preferably 0.05 mass %≤[O]≤0.30 mass %. The jet mill pulverization is performed in an atmosphere of inert gas such as nitrogen. The pulverization may be performed by, for example, a jet mill in a humidified atmosphere. Preferably, the powder particles are reduced in size (the average particle size is preferably 2.0 μm or more and 10.0 μm or less, more preferably 2.0 μm or more and 8.0 μm or less, still more preferably 2.0 μm or more and 4.5 μm or less, and further preferably 2.0 μm or more and 3.5 μm or less). By reducing the size of the powder particles, high H_{cJ} can be obtained.

The fine powder to be used for the preparation of the sintered R-T-B based body may be prepared from one type of raw material alloy (single raw material alloy) or alternatively may be prepared by a method of mixing two or more types of raw material alloys (a blend method) as long as the above-described conditions are satisfied.

In a preferred embodiment, a powder compact is prepared from the above-mentioned fine powder by pressing in a magnetic field, and then the powder compact is sintered. In the pressing in a magnetic field, it is preferable to form a powder compact by pressing in an inert gas atmosphere or wet pressing from the viewpoint of inhibiting oxidation. Especially in wet pressing, the surfaces of particles constituting the powder compact are covered with a dispersant such as an oil, and are inhibited from coming into contact with oxygen and water vapor in the air. For this reason, it is possible to prevent or inhibit the particles from being oxidized by the air before and after the pressing step or during the pressing step. Therefore, the oxygen content can be easily controlled within a prescribed range. In the case of performing wet pressing in a magnetic field, a slurry in which a dispersion medium is mixed with a fine powder is prepared, fed into a cavity in a mold of a wet press device, and press-molded in the magnetic field.

Next, the compact is sintered to afford a sintered R-T-B based body. The sintering of the compact is preferably performed at a temperature in the range of 950° C. to 1150° C. In order to prevent oxidation due to the sintering, the residual gas in the atmosphere may be replaced by an inert gas such as helium or argon. The sintered body obtained may be subjected to a heat treatment. As heat treatment conditions such as heat treatment temperature and heat treatment time, known conditions may be adopted.

The sintered R-T-B based body may be prepared using a known method such as a press-less process (PLP) described in, for example, JP 2006-019521 A without performing molding or the like.

### (Step of Preparing R-M Alloy)

In the present embodiment, the alloy containing R and M is diffused from a surface to the inside of the sintered R-T-B based body. For performing this, an R-M alloy containing the elements to be diffused is prepared.

First, the composition of the R-M alloy will be described. R in the R-M alloy is a rare earth element, and contains one or two selected from the group consisting of Nd and Pr. Preferably, R accounts for 65 mass % or more and 100 mass % or less of the entire R-M alloy, and M is at least one selected from the group consisting of Ga, Cu, Zn, Al, and Si, and necessarily contains Cu. Preferably, R accounts for 0 mass % or more and 35 mass % or less of the entire R-M alloy. Preferably, R necessarily contains Pr, and the content of Pr in R is preferably 65 mass % or more and 86 mass % or less with respect to the entire R-M alloy. Preferably, the content of Pr in the R-M alloy is 50 mass % or more of the entire R, and more preferably, the content of Pr in the R-M alloy is 65 mass % or more of the entire R. When Pr is contained, diffusion in the grain boundary phase easily proceeds, so that grain boundary diffusion can be promoted, and higher H_{cJ} can be obtained.

The shape and size of the R-M alloy are not particularly limited, and may be any shape and size. The R-M alloy may be in the form of film, foil, powder, blocks, particles or the like.

Next, a method for preparing the R-M alloy will be described.

The R-M alloy may be prepared by a method for producing a raw material alloy that is adopted in methods for producing common sintered R-T-B based magnets, e.g., a mold casting method, a strip casting method, a single roll rapid quenching method (melt spinning method), and an atomization method. The R-M alloy may be one obtained by pulverizing the alloy obtained as described above by a known pulverizing means such as a pin mill.

### (Diffusion Step)

A diffusion step is performed in which at least a part of the R-M alloy is brought into contact with at least a part of a surface of the sintered R-T-B based body prepared by the above-described method and then R and M are diffused into the magnet by performing the first heat treatment at a temperature of 700° C. or more and 950° C. or less in a vacuum or an inert gas atmosphere. As a result, a liquid phase containing R and M is generated from the R-M alloy, and the elements forming the liquid phase are diffused and introduced from a surface of the sintered body to the inside thereof via the grain boundaries in the sintered R-T-B based body.

When the first heat treatment temperature is lower than 700° C., for example, the amount of the liquid phase containing R and M is excessively small, so that high H_{cJ} cannot be obtained. On the other hand, when the first heat treatment temperature exceeds 950° C., there is a possibility that H_{cJ} decreases. The first heat treatment temperature is preferably 850° C. or more and 950° C. or less. Within such a range, a higher H_{cJ} can be obtained. Preferably, the sintered R-T-B based magnet subjected to the first heat treatment (700° C. or more and 950° C. or less) is cooled to 300° C. at a cooling rate of 5° C./min or more from the temperature at which the first heat treatment is performed. Within such a range, a higher H_{cJ} can be obtained. More preferably, the cooling rate to 300° C. is 15° C./min or more.

The first heat treatment can be performed by using a known heat treatment apparatus with an R-M alloy having an arbitrary shape disposed on a surface of the sintered R-T-B based body. For example, the first heat treatment may be performed with the surface of the sintered R-T-B based body covered with a powder layer of the R-M alloy. For example, a slurry in which the R-M alloy is dispersed in a dispersion medium may be applied to the surface of the sintered R-T-B based body, and then the dispersion medium may be evaporated to bring the R-M alloy into contact with the sintered R-T-B based body. Examples of the dispersion medium include alcohols (ethanol and the like), aldehydes, and ketones. In addition, a film of the R-M alloy may be formed on a surface of the sintered R-T-B based body, for example, with a known sputtering device or the like, followed by the first heat treatment. The heavy rare earth element RH may be introduced not only from the R-M alloy but also introduced by arranging a fluoride, an oxide, an acid fluoride, or the like of the heavy rare earth element RH together with the R-M alloy on a surface of the sintered R-T-B based magnet. Examples of the fluoride, oxide, and acid fluoride of the heavy rare earth element RH include TbF₃, DyF₃, Tb₂O₃, Dy₂O₃, TbOF, and DyOF.

The R-M alloy may be disposed at any position as long as at least a part of the R-M alloy is in contact with at least a part of the sintered R-T-B based body.

(Step of performing second heat treatment)

The sintered R-T-B based body resulting from the first heat treatment is then subjected to a heat treatment in a vacuum or an inert gas atmosphere at a temperature that is 400° C. or more and 750° C. or less and is lower than the temperature at which the first heat treatment has been performed. In the present disclosure, this heat treatment is referred to as a second heat treatment. By performing the second heat treatment, high H_{cJ} can be obtained. When the temperature of the second heat treatment is higher than that of the first heat treatment or when the temperature of the second heat treatment is lower than 400° C. or higher than 750° C., high H_{cJ} may not be obtained.

### EXAMPLES

Raw materials of each of the elements were weighed such that the sintered R-T-B based bodies would have the compositions shown in Nos. A through D in Table 1, and alloys were produced by a strip casting method. Each of the alloys obtained was coarsely pulverized by hydrogen pulverization, affording a coarsely pulverized powder. Next, to the coarsely pulverized powder obtained, zinc stearate as a lubricant was added in an amount of 0.04 mass % with respect to 100 mass % of the coarsely pulverized powder, followed by mixing. Then, the mixture was dry-pulverized in a nitrogen flow using an airflow crusher (jet mill machine), affording finely pulverized powder (alloy powder) having an average particle size D₅₀ of 3 μm.

Zinc stearate as a lubricant was added to the finely pulverized powder in an amount of 0.05 mass % with respect to 100 mass % of the finely pulverized powder, followed by mixing, and then the mixture was molded in a magnetic field, affording a compact. As a pressing apparatus, a so-called orthogonal magnetic field pressing apparatus (transverse magnetic field pressing apparatus) was used, in which the direction of magnetic field application was orthogonal to the pressurizing direction. The compact obtained was sintered at a temperature of 1060° C. or more and 1090° C. or less (a temperature at which a sufficiently densification caused by sintering would occur was chosen for each sample) for 4 hours, affording a sintered R-T-B based body. The sintered R-T-B based body obtained had a density of 7.5 Mg/m³ or more. The results of the components of the sintered R-T-B based bodies obtained are shown in Table 1. Each of the components in Table 1 was measured using high-frequency inductively coupled plasma optical emission spectroscopy (ICP-OES). The O (oxygen) content was measured using a gas analyzer by a gas fusion-infrared absorption method. The same applies to the results on the components of the R-M alloy and the sintered R-T-B based magnet.

TABLE 1

| | Composition of sintered R-T-B based body (mass %) | | | | | | | | |
|---|---|---|---|---|---|---|---|---|---|
| No. | Nd | Pr | B | Co | Al | Cu | Ga | Zr | Fe |
| A | 23.0 | 5.5 | 0.85 | 0.11 | 0.02 | 0.04 | 0.52 | 0.11 | bal. |
| B | 22.9 | 5.4 | 0.88 | 0.11 | 0.04 | 0.04 | 0.53 | 0.11 | bal. |
| C | 22.9 | 5.4 | 0.87 | 0.11 | 0.03 | 0.04 | 0.01 | 0.11 | bal. |
| D | 22.9 | 5.4 | 0.95 | 0.11 | 0.04 | 0.04 | 0.52 | 0.11 | bal. |

Raw materials of the respective elements were weighed such that the R-M alloy would have approximately the compositions shown in Nos. a and b in Table 2, and these raw materials were melted and alloys in a ribbon or flake form were obtained by a single roll rapid quenching method (melt spinning method). Each of the alloys obtained was pulverized in an argon atmosphere using a mortar, and then was passed through a sieve with a mesh size of 425 μm, and thus R-M alloys were prepared. The compositions of the R-M alloys obtained are shown in Table 2.

TABLE 2

| | Composition of R—M alloy (mass %) | | |
|---|---|---|---|
| No. | Pr | Cu | Ga |
| a | 90 | 10 | 0 |
| b | 90 | 3 | 7 |

The sintered R-T-B based bodies of Nos. A through D in Table 1 were each cut and ground into a 7.4 mm×7.4 mm×7.4 mm cube. Next, the R-M alloy (No. a or b) was spread on the entire surface of each of the sintered R-T-B based bodies of Nos. A through D at a ratio of 3 mass % with respect to 100 mass % of the each of the sintered R-T-B based bodies. In the diffusion step, the first heat treatment was performed at 900° C. for 4 hours in argon under reduced pressure controlled to 50 Pa, and then the mixture was cooled to room temperature. As a result, a sintered R-T-B based magnet resulting from the first heat treatment was obtained. Furthermore, the sintered R-T-B based magnet resulting from the first heat treatment was subjected to the second heat treatment at 500° C. for 1 hour in argon under reduced pressure controlled to 50 Pa, and then cooled to room temperature, and thus sintered R-T-B based magnets (Nos. 1 to 4) were prepared.

In Table 3 are shown the amount of R (Nd+Pr in this experiment example), the amount of oxygen (O), the amount of carbon (C), and the value of (([Nd]+[Pr]+[Ce]+[Dy]+[Tb])−12([O]+[C])) in the sintered R-T-B based magnets obtained. It has been confirmed that all of Nos. 1 to 3 satisfy Formula 1 of the present disclosure. In addition, the sintered R-T-B based magnets obtained were mechanically processed into samples sized 7 mm×7 mm×7 mm, and the samples were measured with a BH tracer. The measurement results are shown in Table 4. Each of the magnet samples Nos. 1 through 4 was cut along a plane parallel to a surface and passing through the vicinity of the central portion of the magnet, and in the cross section, the part from the magnet surface to the vicinity of the central portion of the magnet was subjected to line analysis by EDX. In all the samples, it was confirmed that the concentrations of Pr and Cu gradually decreased from a surface of the magnet toward a depth of 200 μm (the concentrations gradually decreased).

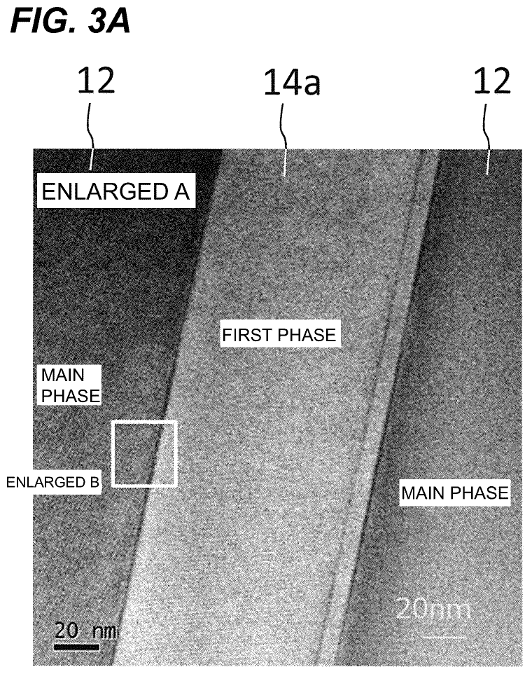

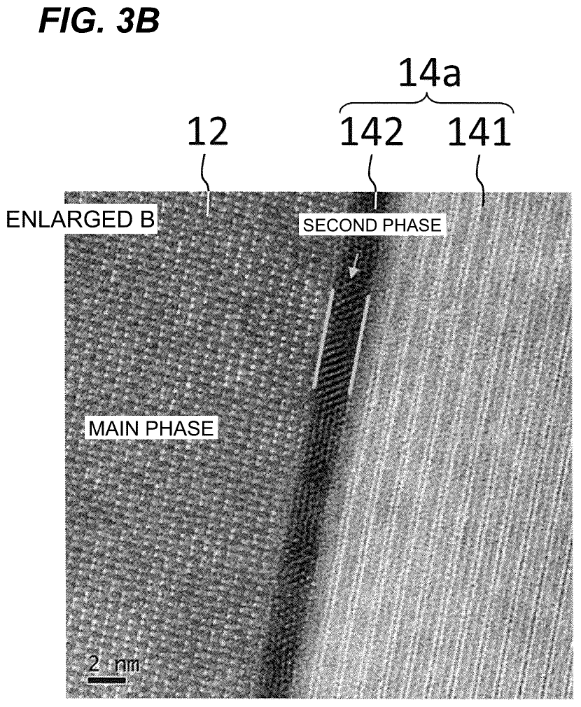

Each of the cross sections of the sintered R-T-B based magnets of Nos. 1 through 4 was analyzed by FE-TEM/WDX/EDX (field emission scanning electron microscope/wavelength dispersive X-ray analysis—energy dispersive X-ray analysis). At this time, in order to eliminate the influence of elements diffused from the surface, analysis was performed at a position 3000 μm or more away from the surface. FIGS. 3A and 3B are cross-sectional TEM photographs of the sintered R-T-B based magnet of No. 1.

First, the cross section was observed with TEM at 1 million magnifications, and a TEM image of the intergranular grain boundary phase 14a between two adjacent crystal grains 12 was taken (FIG. 3A). When a plurality of intergranular grain boundaries can be confirmed, any one intergranular grain boundary is chosen. Then, the vicinity of the interface between any one of the two adjacent crystal grains 12 and the intergranular grain boundary phase 14a in contact with the crystal grain 12 was further subjected to TEM observation of the cross section at 8 million magnifications (FIG. 3B). As can be seen from the TEM photograph of FIG. 3B, the intergranular grain boundary phase 14a included a first phase 141 appearing whiter than a crystal grain 12 and a belt-like second phase 142 appearing black between the crystal grain 12 and the first phase 141.

Similarly, TEM observation of Nos. 2 and 3 confirmed that the intergranular grain boundary phase 14a contained the first phase 141 and the second phase 142. Regarding No. 4, the intergranular grain boundary phase 14a was composed of only the first phase 141, and the second phase 142 was not confirmed.

For Nos. 1 to 3, each of the first phase 141 and the second phase 142 specified in the TEM image was subjected to point analysis by EDX, and the amounts of the elements contained in each phase were specified. For No. 4, the first phase 141 was subjected to point analysis by EDX. The results of the point analysis are shown in Table 4. In all of Nos. 1 to 3, it was confirmed that the Cu concentration of the second phase 142 was higher than the Cu concentration of the first phase 141. As shown in Table 4, in Nos. 1 to 3 satisfying the conditions of the present disclosure, there was no large decrease in Bᵣ and high H_{cJ} was obtained, as compared with the comparative example (No. 4).

TABLE 3

| | | Diffusion | Composition of sintered R-T-B based magnet (mass %) | | | | | | | | | | | |
|---|---|---|---|---|---|---|---|---|---|---|---|---|---|---|
| No. | Materials | source | Nd | Pr | B | Co | Al | Cu | Ga | Zr | Fe | O | C | Formula 1 |
| 1 | A | a | 22.3 | 7.6 | 0.84 | 0.10 | 0.05 | 0.33 | 0.49 | 0.11 | 68.2 | 0.10 | 0.12 | 27.3 |
| 2 | B | a | 22.1 | 6.8 | 0.87 | 0.10 | 0.04 | 0.22 | 0.41 | 0.11 | 69.4 | 0.10 | 0.12 | 26.3 |
| 3 | C | b | 22.1 | 7.3 | 0.86 | 0.10 | 0.04 | 0.11 | 0.20 | 0.11 | 69.2 | 0.10 | 0.12 | 26.8 |
| 4 | D | a | 22.1 | 6.5 | 0.95 | 0.10 | 0.04 | 0.21 | 0.41 | 0.11 | 69.6 | 0.11 | 0.12 | 25.9 |

TABLE 4

| | Analysis | Point analysis result (mass %) | | | | | | | | Br | HcJ |
|---|---|---|---|---|---|---|---|---|---|---|---|
| No. | position | Fe | Nd | Pr | Co | Cu | Ga | O | F | T | kA/m |
| 1 | First phase | 40.9 | 23.6 | 26.6 | 0.7 | 0.5 | 4.3 | 2.0 | 1.4 | 1.41 | 1779 |
| | Second phase | 27.5 | 24.2 | 29.6 | 0.9 | 2.5 | 1.9 | 2.4 | 11.0 | | |
| 2 | First phase | 46.2 | 21.7 | 24.6 | 0.5 | 0.6 | 4.0 | 1.6 | 0.8 | 1.43 | 1742 |
| | Second phase | 32.4 | 21.3 | 27.0 | 1.4 | 3.6 | 3.7 | 3.0 | 7.6 | | |
| 3 | First phase | 42.3 | 23.0 | 26.5 | 0.5 | 0.6 | 4.0 | 2.0 | 1.1 | 1.45 | 1625 |
| | Second phase | 37.8 | 23.3 | 28.5 | 0.3 | 2.2 | 2.1 | 2.9 | 2.9 | | |
| 4 | — | 32.5 | 24.0 | 29.6 | 0.6 | 1.9 | 1.8 | 3.4 | 6.2 | 1.47 | 1317 |

What is claimed is:

1. A sintered R-T-B based magnet comprising:
R: 26.8 to 31.5 mass % (R is a rare earth element, and contains one or two selected from the group consisting of Nd and Pr);
M: 0.05 to 2.00 mass % (M is at least one selected from the group consisting of Ga, Cu, Zn, Al, and Si, and necessarily contains Cu);
B: 0.84 to 0.94 mass %; and
T: 61.5 mass % or more (T is Fe and Co, and 90% or more of T is Fe in mass ratio), and
having an internal structure,
wherein the internal structure includes:
crystal grains;
a first phase between adjacent two crystal grains; and
a second phase with a Cu concentration higher than that of the first phase between the first phase and one or each of the two crystal grains and,
wherein the second phase contains F in a range of 2 to 20 mass % and has a higher F concentration than the first phase.

2. The sintered R-T-B based magnet according to claim 1, wherein the second phase is included between the first phase and each of the two crystal grains.

3. The sintered R-T-B based magnet according to claim 1,
wherein the first phase comprises:
R: 15 to 65 mass %;
M: 2 to 20 mass %;
F: 3 mass % or less (including 0 mass %); and
T: 20 to 80 mass %, and
the second phase comprises:
R: 15 to 65 mass %;
M: 2 to 20 mass %;
F: 2 to 20 mass %; and
T: 20 to 80 mass %.

4. The sintered R-T-B based magnet according to claim 1, wherein the concentration of the one or two selected from the group consisting of Nd and Pr and the Cu concentration gradually decrease in a range from a surface to a depth of 200 μm.

5. The sintered R-T-B based magnet according to claim 1, wherein M further necessarily contains Ga.

6. The sintered R-T-B based magnet according to claim 1, further comprising at least one selected from the group consisting of:
Tb: more than 0 mass % and 0.10 mass % or less, and
Dy: more than 0 mass % and 0.20 mass % or less.

7. The sintered R-T-B based magnet according to claim 1, satisfying the following Formula (1):
$$26. mass \% \leq ( [ Nd ] + [ Pr ] + [ Ce ] + [ La ] + [ Dy ] + [ Tb ] ) - 12 ( [ O ] + [ C ] ) \leq 27.7 mass \% \qquad ( 1 )$$
wherein [Nd], [Pr], [Ce], [La], [Dy], [Tb], [O], and [C] are contents of Nd, Pr, Ce, La, Dy, Tb, O, and C expressed in mass %, respectively.
